(19) United States
(12) Patent Application Publication
(10) Pub. No.: US 2026/0318581 A1
(43) Pub. Date: Oct. 15, 2026

(54) TRAY FOR ICE MAKER

(71) Applicant: S PLUS COMTECH CO., LTD., Seoul (KR)

(72) Inventors: Dongsoo SHIN, Seoul (KR); Sangho KIM, Seoul (KR)

(21) Appl. No.: 19/112,041

(22) PCT Filed: Sep. 11, 2023
(86) PCT No.: PCT/KR2023/013547

§ 371 Date: Mar. 14, 2025

(30) Foreign Application Priority Data
Sep. 14, 2022 (KR) 10-2022-0115347
Sep. 14, 2022 (KR) 10-2022-0115350

(51) Int. Cl. F25C 1/10; H05B 3/03

(52) U.S. Cl. CPC F25C 1/10; H05B 3/03; F25C 2305/0221; F25C 2500/08

(57) ABSTRACT

A tray for an ice maker comprises: a tray body which is molded from a conductive composite material including a conductive material and a base resin, wherein the conductive material forms an electrical network and generates heat through electrical resistance, thus enabling separation of ice; and power terminals which receive external power and supply power to the tray body, wherein a plurality of ice-making compartments are provided in at least two rows in the tray body, and the plurality of power terminals are configured so that positive and negative polarities are alternately changed from one end surface to the other end surface on the basis of the left and right direction of the tray body.

### TECHNICAL FIELD

The present invention relates to a tray for an ice maker that is capable of being heated by itself when external power is applied thereto so that ice is easily separated therefrom.

### BACKGROUND ART

Generally, an ice maker is a device that artificially produces a large amount of ice at home or at a restaurant.

A tray for producing ice in a conventional ice maker is made of a plastic or aluminum material, and methods for separating the ice from the tray are different according to the materials of the tray.

If the tray is made of a plastic material, the tray becomes twisted to allow the ice to be separated therefrom. In this case, however, the tray is weak in durability and has limitations in producing a large amount of ice.

If the tray is made of an aluminum material, a heater is additionally located on the underside of the tray, and with the heat applied from the heater, accordingly, the ice in the tray melts slightly, so that the ice is separated from the tray. In the case of making the tray made of the aluminum material, however, a corrosion prevention film has to be formed on the surfaces of the tray by means of anodizing, which causes the manufacturing process of the tray to become complicated, and as such additional heater is provided for the tray, further, a manufacturing cost of the tray becomes raised.

To solve such problems, an ice maker using a conductive composite material, which is disclosed in Korean Patent No. 10-2302921, has been suggested to achieve easy manufacturing process and low manufacturing cost.

However, the conventional technology as disclosed in the above-mentioned Patent document fails to allow a conductive material to evenly disperse into base resin (non-conductive resin) with ease, thereby unfortunately having limitations in maximizing heat dissipation performance of the tray.

### DISCLOSURE OF THE INVENTION

### Technical Problems

Accordingly, the present disclosure has been made in view of the above-mentioned problems occurring in the related art, and it is an object of the present invention to provide a tray for an ice maker that is capable of allowing base resin and a conductive material (carbon members) to be mixed well so that the carbon members efficiently disperse into the base resin, and capable of making use of nylon resin as the base resin so that heat dissipation performance and stiffness of the tray are maximized.

### Technical Solutions

To accomplish the above-mentioned objects, according to the present invention, there is provided a tray for an ice maker, the tray including: a tray body in which an ice-making space is provided allowing at least a portion thereof to be made of a conductive composite material containing a conductive material and base resin by means of injection molding so that upon application of external power, the conductive material forms electrical networks and generates heat through electrical resistance, thereby enabling separation of ice produced therein; and power terminals inserted into the tray body, receiving the external power, and supplying the external power to the tray body, wherein the tray body has a plurality of ice-making compartments arranged in at least two rows in left and right directions thereof in such a way as to be spaced apart from one another in forward and backward directions thereof, and the power terminals are inserted into one side end surface of the tray body with respect to the left and right directions of the tray body, between the at least two rows of ice-making compartments, and into the other side end surface of the tray body with respect to the left and right directions of the tray body in such a way as to allow positive and negative polarities to be alternately changed from one side end surface to the other side end surface with respect to the left and right directions of the tray body.

The conductive material may include: carbon members dispersing into the base resin to form the electrical networks and containing at least one or more materials of carbon nanotubes, graphene, carbon fibers, and graphite filler; and metal powder interposed between the carbon members to increase the electrical networks formed by the carbon members and thermal conductivity of the conductive composite material so that electrical resistance heat generated from the carbon members may be transferred to the surfaces of the tray body.

The carbon members may contain all of the carbon nanotubes, graphene, carbon fibers, and graphite filler.

Based on the total weight of the conductive composite material, the content of the carbon nanotubes may be 10 to 17% by weight, the content of the graphene may be 1 to 1.7% by weight, the content of the carbon fibers may be 2 to 5% by weight, the content of the graphite filler may be 10 to 50% by weight, and the content of the metal powder may be 12 to 22% by weight.

The base resin may be PA6 or PA66 nylon and contain 20 to 60% by weight of the PA6 or PA66 nylon, based on the total weight of the conductive composite material, and the base resin may include conductive resin such as Polypyrrole (PPy) as well as the non-conductive resin such as the PA6 or PA66 nylon and contain 0 to 10% by weight of the conductive resin.

The tray body may be molded integrally with the power terminals by means of insert injection molding so that one end of each power terminal may be exposed to the outside.

### Advantageous Effects of the Invention

According to the present invention, the tray for an ice maker includes the carbon members of the conductive material, such as carbon nanotubes, graphene, carbon fibers, and graphite filler, so that the base resin and the conductive material (carbon members) are mixed well to allow the carbon members to efficiently disperse into the base resin, thereby maximizing the heat dissipation performance of the tray body and improving the injection properties thereof.

Further, the tray for an ice maker according to the present invention makes use of the PA6 or PA66 as the base resin so that the heat dissipation performance and stiffness of the tray body can be greatly improved.

Furthermore, the tray for an ice maker according to the present invention is configured to have the plurality of power terminals inserted into the tray body in such a way as to allow positive and negative polarities to be alternately changed from one side end surface to the other side end surface with respect to the left and right directions of the tray body, so that heat is quickly and evenly transmitted to the ice-making compartments to allow the ice produced in the ice-making compartments to be separated from the tray body with ease.

### BRIEF DESCRIPTION OF DRAWINGS

FIG. 1 is a perspective view showing a tray for an ice maker according to an embodiment of the present invention.

FIG. 2A to 2C are a front sectional view showing variations of the tray for an ice maker according to the embodiment of the present invention.

FIGS. 3A and 3B are a sectional view showing an operating state of the tray for an ice maker according to the embodiment of the present invention.

### BEST MODE FOR INVENTION

Hereinafter, an embodiment of the present invention will be described in detail below with reference to the accompanying drawings. However, the present invention may be modified in various ways, without being limited to the embodiment as will be described below, and the embodiment of the present invention allows the disclosure to be perfect and makes the scope of the present invention completely recognized by one of ordinary skill in the art. Through the accompanying drawings, the same reference numerals will be used to describe the same components.

A tray for an ice maker according to a desirable embodiment of the present invention is made of a conductive composite material containing a conductive material by means of injection molding, and upon the injection molding, in this case, power terminals are inserted into a tray body and molded integrally with the tray body. If external power is applied to the power terminals, the conductive material forms the electrical networks and generates heat so that since there is no need to install an additional heater on the tray body, the tray is simple in configuration, easy in manufacturing process, decreases in manufacturing cost, and enables easy separation of ice therefrom.

Hereinafter, an embodiment of the present invention will be described in detail.

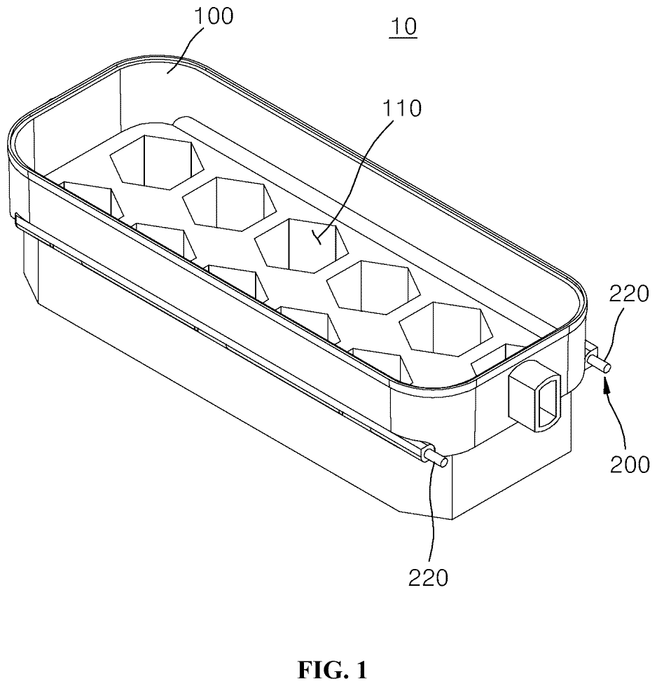

As shown in FIG. 1, a tray 10 for an ice maker (hereinafter, referred to as ‘tray’) according to an embodiment of the present invention is provided to form an ice-making space in which water fed is received, cooled by a cooling device (not shown), and turns into ice, and in this case, for example, the tray 10 extends in length in left and right (or forward and backward) directions and has a plurality of concaved ice-making compartments 110 defined therein to produce a plurality of ice pieces.

According to the embodiment of the present invention, the tray 10 includes a tray body 100 and power terminals 200. Hereinafter, an explanation of materials for constituting the tray body 100 will be first given, and explanations of a specific shape and structure of the tray body 100 and heating of the tray body 100 through which ice is separated from the tray will be given later.

The tray body 100 in which the ice-making space is provided allows at least a portion thereof to be made of a conductive composite material containing a conductive material and base resin by means of injection molding, and if external power is applied thereto, in this case, the conductive material forms electrical networks and generates heat through electrical resistance, thereby enabling separation of ice made therein. Further, the tray body 100 is connected to a rotation and ejection device (not shown) that rotates the tray body 100, falls down the ice melted to a given degree by means of the heating (heat dissipation) of the tray body 100, and separates the ice from the tray body 100.

Further, the power terminals 200 are inserted into the tray body 100, receive the external power, and supply the external power to the tray body 100. In this case, two to four power terminals whose lengths are long are inserted into the tray body 100, while being spaced apart from one another.

According to the embodiment of the present invention, the tray body 100 is molded integrally with the power terminals 200 by means of insert injection molding so that one end of each power terminal 200 is exposed to the outside. As a result, additional works for fixing the power terminals 200 to the tray body 100 are not needed, thereby improving the productivity of the tray. The end portions of the power terminals 200 that are exposed to the outside are electrically connected to a power supply device (not shown). Further, the central portion of each power terminal 200 as well as one end portion of each power terminal 200 may be exposed to the outside by means of injection molding.

According to the embodiment of the present invention, the conductive composite material constituting the tray body 100 includes the conductive material, the base resin, a stabilizer, and an adhesive (other additives, wax, etc.).

In this case, the conductive material consists of carbon members and metal powder.

The carbon members disperse into the base resin to form the electrical networks and include at least one or more materials of carbon nanotubes (CNTs), graphene, carbon fibers, and graphite filler.

Desirably, the carbon members include all of the carbon nanotubes, graphene, carbon fibers, and graphite filler, and therefore, an explanation as will be given later is based on the carbon members consisting of all of the above-mentioned materials.

Above all, the graphite filler serves to allow the base resin as will be discussed later and the carbon members to be mixed well to enable the carbon members to efficiently disperse into the base resin, so that heating (heat dissipation) performance of the tray body 100 can be maximized.

Further, the graphite filler has oxidation prevention characteristics and reinforces the sealing properties of the tray body 100.

According to the embodiment of the present invention, the carbon members of the conductive composite material each have a length of 1 to 100 μm, and to allow the carbon members to form stable and efficient electrical networks, the content of the carbon members is determined appropriately with the following ratios.

In detail, the conductive composite material desirably comprises 10 to 17% by weight of the carbon nanotubes, 1 to 1.7% by weight of the graphene, 2 to 5% by weight of the carbon fibers, and 10 to 50% by weight of the graphite filler.

In this case, if the content of the carbon nanotubes is less than 10% by weight, the conductive composite material has low electrical conductivity, so that as the heating value of the tray body 100 decreases, it is hard to quickly separate the ice from the tray, thereby causing the product to have no functional practicability. Contrarily, if the content of the carbon nanotubes is greater than 17% by weight, the conductive composite material has high electrical conductivity, but the heating value of the tray body 100 increases unnecessarily over the heating value as required for separation of ice, while the injection molding is being deteriorated badly.

If the content of the graphene is less than 1% by weight, the conductive composite material has low electrical conductivity due to uneven dispersion. Contrarily, if the content of the graphene is greater than 1.7% by weight, the conductive composite material has high electrical conductivity, but a product price is raised to cause low cost effectiveness.

If the content of the carbon fibers is less than 2% by weight, an electrical conductivity networks become weakened and irregular conductivity appears. Contrarily, if the content of the carbon fibers is greater than 5% by weight, the injection molding performance of the tray body 100 becomes deteriorated badly.

If the content of the graphite filler is less than 10% by weight, it is hard to obtain an optimized state in which the carbon members are mixed well with the base resin and efficiently disperse thereinto, so that heating (heat dissipation) performance of the tray body 100 cannot be maximized. Contrarily, if the content of the graphite filler is greater than 50% by weight, the injection molding performance of the tray body 100 becomes deteriorated badly.

Next, the metal powder is interposed between the carbon members to increase the electrical networks formed by the carbon members and the thermal conductivity of the conductive composite material, so that electrical resistance heat generated from the carbon members is transferred to the surfaces of the tray body 100.

If the metal power is not contained in the conductive material, further, the thermal conductivity of the conductive composite material becomes low to a level similar to the thermal conductivity of the base resin (non-conductive resin), so that the electrical resistance heat generated from the carbon members is not efficiently transferred to the surfaces of the tray body 100 due to the base resin (non-conductive resin) having very low thermal conductivity, thereby failing to efficiently separate the ice from the tray body.

The metal powder has a diameter of 10 to 100 nm, and desirably, the content of the metal powder is greater than or equal to 12% by weight to increase the electrical networks of the carbon members and the thermal conductivity of the conductive composite material and less than or equal to 22% by weight to decrease the specific gravity of the conductive composite material. According to the embodiment of the present invention, aluminum powder is used as the metal powder.

Next, the base resin is a base material constituting the tray body 100, and PA6 or PA66 nylon, which is non-conductive resin, is used as the base resin. Of course, the base resin additionally includes PP, PE, ABS, etc., but to increase the thermal conductivity (that is, heat dissipation characteristics) and stiffness of the tray body 100, desirably, the base resin consists of only PA6 or PA66.

Further, nylon resin is relatively lower in price than the PP, PE, and ABS, thereby improving the profitability of the product. According to the embodiment of the present invention, the PA6 or PA66 nylon as non-conductive resin is used as the base resin.

If the PA6 or PA66 nylon is used as the base resin, further, the injection molding properties may be more deteriorated than those if the PP, PE, and ABS are used as the base resin, but the heat dissipation characteristics and stiffness of the tray body 100 increase greatly so that the original functions of the tray body 100 for producing the ice and separating the produced ice can be more efficiently and stably performed.

According to the embodiment of the present invention, the conductive composite material desirably includes 20 to 60% by weight of the base resin, that is, the PA6 or PA66 nylon.

In this case, if the content of the PA6 or PA66 nylon is less than 20% by weight, the rate of the carbon materials (carbon members) of the materials constituting the tray body 100 relatively increases, thereby causing bad injection molding. Contrarily, if the content of the PA6 or PA66 nylon is greater than 60% by weight, the heating performance of the tray body itself becomes deteriorated, and in the case of the high-priced PA66 nylon, further, a product price disadvantageously increases.

According to another embodiment of the present invention, the base resin includes conductive resin such as Polypyrrole (PPy) as well as the PA6 or PA66 nylon as non-conductive resin, and in this case, the base resin includes 0 to 10% by weight of the conductive resin. Like this, if the base resin includes the conductive resin such as Polypyrrole (PPy) as well as the non-conductive resin such as the PA6 or PA66 nylon, the electrical characteristics (electrical conductivity and thermal conductivity) of the conductive composite material are improved greatly.

Next, the conductive composite material includes 0.1 to 0.6% by weight of the stabilizer and 0.4 to 2.1% by weight of the adhesive and wax.

As shown in FIG. 1, the power terminals 200 are inserted into the tray body 100, receive the external power, and supply the external power to the tray body 100, particularly to the conductive material constituting the tray body, and in this case, the two or more power terminals 200 are disposed in the tray body 100.

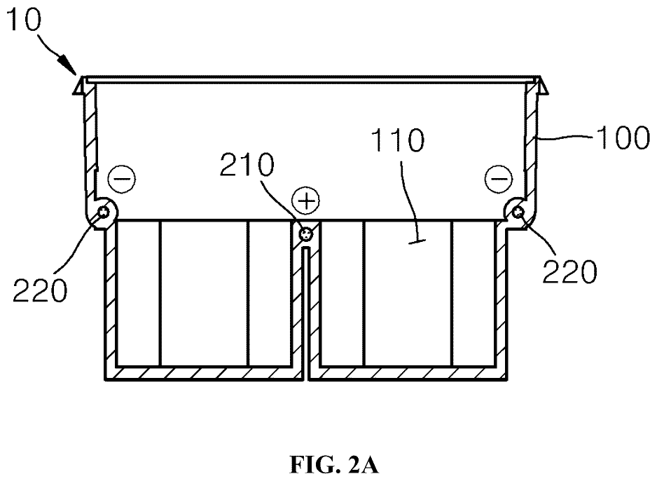

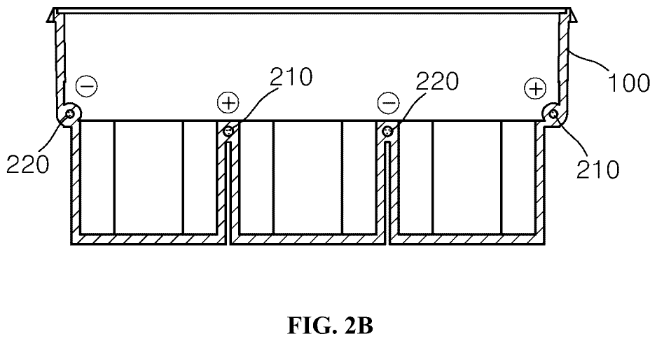

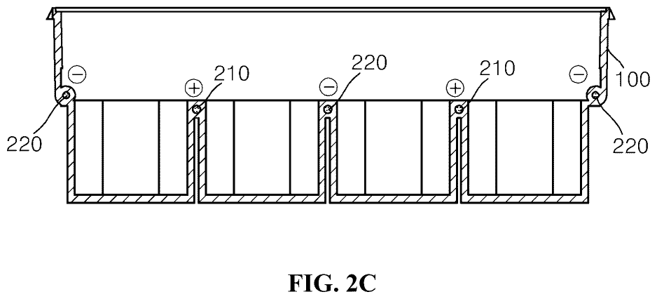

In detail, as shown in FIG. 2a, if the ice-making compartments 110 are provided in two rows in the tray body 100, the two to four power terminals 200 are inserted into the tray body 100. The power terminals 200 are inserted into the tray body upon the injection molding of the tray body and molded integrally with the tray body, without being additionally coupled to the tray body.

As shown, a positive power terminal 210 is inserted between the two rows of ice-making compartments 110, and negative power terminals 220 are spaced apart from the positive power terminal 210 in such a way as to be inserted into both sides of the two rows of ice-making compartments 110. Hereinafter, an explanation of the power terminals 200 will be given under the above-mentioned configuration.

According to the embodiment of the present invention, the plurality of power terminals 200 are conductive wires that are inserted into the tray body 100 in a longitudinal direction of the tray body 100, but they may not be limited thereto. That is, the lengths or inserted positions of the positive power terminal 210 and the negative power terminals 220 may be freely varied. However, in this case, the positive power terminal 210 and the negative power terminals 220 allow one end portion thereof to be exposed to the outside of the tray body 100 in such a way as to be electrically connected to the power supply device (not shown) with ease.

The positive power terminal 210 and the negative power terminals 220 are selected from aluminum wires, copper and alloy wires, copper wires, and conductive composite material wires, which have relatively high electrical conductivity, and the conductive composite material wires include carbon wires.

If it is desired to produce ice, water is put in the tray body 100 by a user and cooled to turn into ice by means of the cooling device (not shown) of the ice maker. If it is desired to separate the produced ice from the tray body 100, the power is supplied from the power supply device (not shown) to the power terminals 200. In this case, if an electric potential difference occurs by means of the supply of power to the positive power terminal 210 and the negative power terminals 220, heat is generated from the interior of the tray body 100 by means of electrical resistance.

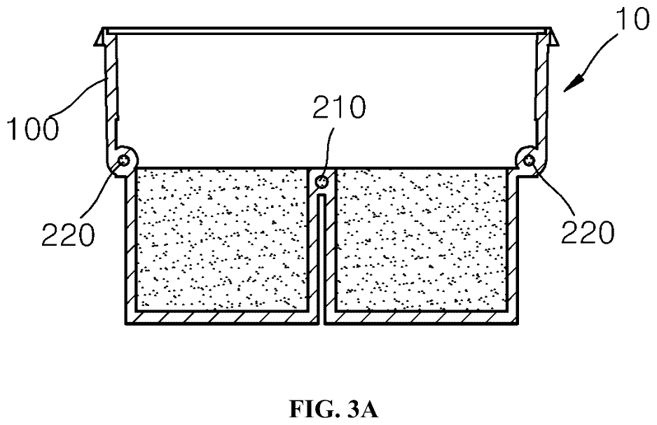

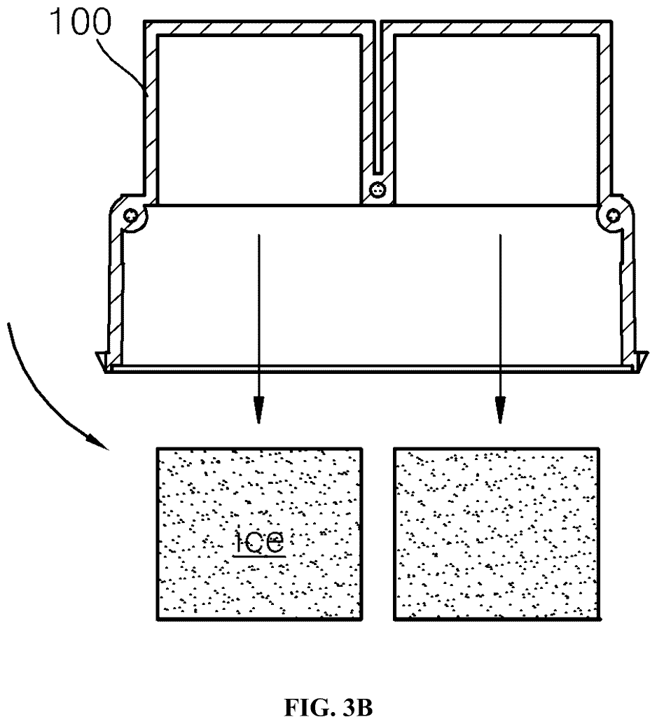

If the tray body 100 is heated, that is, if the surfaces of the tray body 100 coming into contact with the ice are heated, the ice melts slightly so that it is easily separated from the tray body 100. In this state, as shown in FIG. 3, the tray body rotates to fall down the ice.

Hereinafter, an explanation of a method for manufacturing the tray 10 according to the embodiment of the present invention will be given.

First, the carbon members (carbon nanotubes, graphene, carbon fibers, and graphite filler), the metal powder (aluminum powder), the PA6 (or PA66), the stabilizer, and the adhesive are mixed with the above-mentioned respective contents.

Based on the total weight of the conductive composite material, the content of the carbon nanotubes is 10 to 17% by weight, the content of the graphene is 1 to 1.7% by weight, the content of the carbon fibers is 2 to 5% by weight, and the content of the graphite filler is 10 to 50% by weight.

In this case, the contents of the carbon nanotubes, the graphene, the carbon fibers, and the graphite filler are parameters that have influences on the electrical conductivity, that is, on the resistivity of the conductive composite material. In detail, if the contents of the carbon nanotubes, the graphene, the carbon fibers, and the graphite filler are less than the above-mentioned respective numerical ranges, the electrical networks of the carbon members are not formed well, thereby resulting in low electrical conductivity of the tray body 100.

Like this, if the electrical conductivity of the tray body 100 becomes low, the electric current applied to the power terminals 200 is not induced well to the carbon members so that no electricity is connected to the tray body 100 to cause no electrical resistance heat to be generated.

Contrarily, if the contents of the carbon nanotubes, the graphene, the carbon fibers, and the graphite filler are greater than the above-mentioned respective numerical ranges, the electrical conductivity does not increase anymore so that in terms of economical advantages, desirably, the respective contents do not exceed the above-mentioned appropriate numerical ranges.

In the case of the graphite filler, if the content of the graphite filler is less than 10% by weight, it is hard to obtain an optimized state in which the carbon members are mixed well with the base resin and efficiently disperse thereinto, so that heating performance of the tray body cannot be maximized. Contrarily, if the content of the graphite filler is greater than 50% by weight, the injection molding performance of the tray body 100 becomes deteriorated badly.

To allow the conductive composite material to have the electrical conductivity within the appropriate range, it is desirable that the contents of the carbon nanotubes, the graphene, the carbon fibers, and the graphite filler be within the above-mentioned respective numerical ranges.

Further, the content of the metal powder (aluminum powder) is 12 to 22% by weight, based on the total weight of the conductive composite material. The content of the metal powder is a parameter that has influences on the electrical conductivity and thermal conductivity of the conductive composite material. In detail, if the content of the metal powder is less than 12% by weight, the metal powder does not serve as the electrical networks in the carbon members and does not transfer the electrical resistance heat generated from the carbon members to the surfaces of the tray body 100, so that the tray body 100 is not heated to a degree of capable of melting the ice.

Further, if the content of the metal powder is greater than 22% by weight, the specific gravity of the conductive composite material undesirably increases.

According to the embodiment of the present invention, the conductive composite material includes the metal powder (aluminum powder) as well as the carbon members (carbon nanotubes, graphene, carbon fibers, and graphite filler), so that the manufacturing cost of the tray body 100 becomes lower than that of the tray body made of only the carbon members, and the electrical conductivity and thermal conductivity of the tray body 100 are more improved than those of the tray body made of only the carbon members.

Further, the content of the PA6 or PA66 is 20 to 60% by weight, the content of the stabilizer is 0.1 to 0.6% weight, and the content of the adhesive is 0.4 to 2.1% by weight, based on the total weight of the conductive composite material.

The conductive composite material made by mixing the above-mentioned materials in the optimal ratios is injected into a cavity of an injection mold at high temperature and high pressure to mold the tray body 100. In this case, for example, the plurality of power terminals 200 are pre-arranged on given positions of a lower mold of the injection mold, and next, the conductive composite material is injected and made by means of the insert injection molding. If the conductive composite material is cured in the injection mold, the tray body 100 with the power terminals 200 inserted integrally thereinto is separated from the injection mold.

According to the present invention, in detail, the tray body 100 with the power terminals 200 coupled integrally thereto is made by means of a one-time injection molding process, thereby reducing the number of manufacturing processes and the manufacturing cost.

Testing results for the conductive composite material made in the above-mentioned method are as follows.

The specific gravity (based on ASTM D792 test methods) of the conductive composite material containing the conductive material (the carbon members and the metal powder) and the base resin (PA6 or PA66) is 1.0 to 1.7. Further, the resistivity of the conductive composite material is 1 to 10 Ωmm²/m. As the content of the carbon members and the content of the metal powder are mixed in the optimal ratio, the conductive composite material has optimal resistivity so that the tray body 100 made of the conductive composite material by means of the injection molding can have appropriate electrical conductivity and thermal conductivity.

Further, the thermal conductivity of the conductive composite material is in the range of 20 to 120 W/mK. As the thermal conductivity can be varied according to the content of the metal powder, the content of the metal powder is in the range of 12 to 22% by weight in the embodiment of the present invention, so that the conductive composite material can have the thermal conductivity within the above-mentioned range.

As the metal powder is mixed with the carbon members, according to the present invention, the thermal conductivity of the conductive composite material can increase greatly, and the electrical resistance heat generated from the carbon members can be effectively transferred to the surfaces of the tray body 100, so that the ice can be easily separated from the tray body 100.

Further, the tensile strength (based on ASTM D638 test methods) of the conductive composite material is in the range of 180 to 200 kgf/cm², the tensile elongation (based on ASTM D638 test methods) thereof is in the range of 22 to 27% by weight, the flexural modulus (based on ASTM D790 test methods) is in the range of 1,200 to 1,300 kgf/cm², and the flexural strength (based on ASTM D790 test methods) is in the range of 200 to 220 kgf/cm². Through such test results, it can be checked that the tray of the present invention that is made of the conductive composite material by means of the injection molding has good tensile strength and flexural strength.

Hereinafter, explanations of the tray body 100 and the power terminals 200 will be given in more detail.

As shown in FIGS. 1A to 3B, for example, the tray body 100 has the two rows of ice-making compartments 110. Each ice-making compartment 110 is shaped to produce the ice with the shape of a hexagonal or octagonal post.

Therefore, the inner and bottom surfaces for forming the ice-making compartment 110 are flat. Further, the outside surfaces of the ice-making compartments 110 that are exposed to the outside are flat. That is, both sides of the tray body 100 are flat.

According to the embodiment of the present invention, as shown in FIGS. 1 and 2, the ice-making compartments 110 are formed in at least two rows in the left and right directions of the tray body 100, and they are spaced apart from one another in forward and backward directions of the tray body 100.

Further, as shown in FIG. 2, the power terminals are inserted into one side end surface of the tray body 100 with respect to the left and right directions of the tray body 100, between the at least two rows of ice-making compartments 110, and into the other side end surface of the tray body 100 with respect to the left and right directions of the tray body 100.

In this case, the plurality of power terminals are arranged to allow positive and negative polarities to be alternately changed from one side end surface to the other side end surface with respect to the left and right directions of the tray body 100. Accordingly, heat is quickly and evenly transmitted to the ice-making compartments 110 to allow the ice produced in the ice-making compartments 110 to be separated from the tray body 100 with ease.

For example, as shown in FIG. 2a, the plurality of ice-making compartments 110 are provided in two rows, and the positive power terminal 210 is inserted between the two rows of ice-making compartments 110, whereas the negative power terminals 220 are spaced apart from the positive power terminal 210 in such a way as to be inserted into both sides of the two rows of ice-making compartments 110. However, the ice-making compartments may be arranged in one, three, and four or more rows, without being limited thereto.

According to the embodiment of the present invention, the plurality of power terminals 200 are conductive wires that are inserted into the tray body 100 in the longitudinal direction of the tray body 100, but they may not be limited thereto. That is, the lengths or inserted positions of the positive power terminal 210 and the negative power terminals 220 may be freely varied. However, in this case, the positive power terminal 210 and the negative power terminals 220 allow one end portion thereof to be exposed to the outside of the tray body 100 in such a way as to be electrically connected to the power supply device (not shown) with ease.

Without being limited thereto, the number of power terminals 200 inserted into the tray body 100 is varied according to the rows of the ice-making compartments 110 and the shape of the tray body 100, and for example, two to four power terminals may be freely arranged. The number of power terminals 200 inserted into the tray body 100 is determined for even thermal conductivity (heating performance) on the entire surface of the tray body 100, so that heating time for ice separation decreases.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

### INDUSTRIAL APPLICABILITY

The tray for an ice maker according to the present invention allows the base resin and the conductive material (carbon members) to be mixed well so that the carbon members can efficiently disperse into the base resin and makes use of the nylon resin as the base resin so that the heat dissipation performance and stiffness of the tray can be maximized.

1. A tray for an ice maker, comprising:
a tray body in which an ice-making space is provided allowing at least a portion thereof to be made of a conductive composite material containing a conductive material and base resin by means of injection molding so that upon application of external power, the conductive material forms electrical networks and generates heat through electrical resistance, thereby enabling separation of ice produced therein; and
power terminals inserted into the tray body, receiving the external power, and supplying the external power to the tray body,
wherein the tray body has a plurality of ice-making compartments arranged in at least two rows in left and right directions thereof in such a way as to be spaced apart from one another in forward and backward directions thereof, and the power terminals are inserted into one side end surface of the tray body with respect to the left and right directions of the tray body, between the at least two rows of ice-making compartments, and into the other side end surface of the tray body with respect to the left and right directions of the tray body in such a way as to allow positive and negative polarities to be alternately changed from one side end surface to the other side end surface with respect to the left and right directions of the tray body.

2. The tray according to claim 1, wherein the conductive material comprises:
carbon members dispersing into the base resin to form the electrical networks and containing at least one or more materials of carbon nanotubes, graphene, carbon fibers, and graphite filler; and
metal powder interposed between the carbon members to increase the electrical networks formed by the carbon members and thermal conductivity of the conductive composite material so that electrical resistance heat generated from the carbon members is transferred to the surfaces of the tray body.

3. The tray according to claim 2, wherein the carbon members contain all of the carbon nanotubes, graphene, carbon fibers, and graphite filler.

4. The tray according to claim 2, wherein based on the total weight of the conductive composite material, the content of the carbon nanotubes is 10 to 17% by weight, the content of the graphene is 1 to 1.7% by weight, the content of the carbon fibers is 2 to 5% by weight, the content of the graphite filler is 10 to 50% by weight, and the content of the metal powder is 12 to 22% by weight.

5. The tray according to claim 1, wherein the base resin is PA6 or PA66 nylon and contains 20 to 60% by weight of the PA6 or PA66 nylon, based on the total weight of the conductive composite material, and the base resin comprises conductive resin such as Polypyrrole (PPy) as well as the non-conductive resin such as the PA6 or PA66 nylon and contains 0 to 10% by weight of the conductive resin.

6. The tray according to claim 1, wherein the tray body is molded integrally with the power terminals by means of insert injection molding so that one end of each power terminal is exposed to the outside.
